(19) United States
(12) Patent Application Publication
(10) Pub. No.: US 2010/0293227 A1
(43) Pub. Date: Nov. 18, 2010

(54) HEARING SYSTEM, METHOD FOR OPERATING A HEARING SYSTEM, AND HEARING SYSTEM NETWORK

(75) Inventors: Ivo Hasler, Winterthur (CH); Micha Knaus, Jona (CH); Lukas Erni, Zurich (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/679,935

(22) PCT Filed: Oct. 2, 2007
(86) PCT No.: PCT/EP07/60480

§ 371 Date: Mar. 25, 2010

(51) Int. Cl. G06F 15/16

(52) U.S. Cl. 709/204

(57) ABSTRACT

The method for operating a hearing system (1) comprises using a network identifier for identifying messages (9) within a network formed by devices (11, 12, 13, 14) of said hearing system (1). Through this, an improved message management can be achieved. Typically, the network identifier will be used for marking messages (9) as messages (9) within the network (10) and for recognizing messages (9) as messages (9) within the network (10). A device (11; 12; 13; 14) of a hearing system (1) is configured to participate in a network (10), comprises a storage unit (4) in which a network identifier is stored, and is configured to use said network identifier for identifying messages (9) within said network. Messages (9) in the network can comprise, in addition to the network identifier, complementing data, wherein the treatment of further contents of a received message depends on the result of an evaluation of the complementing data.

### TECHNICAL FIELD

The invention relates to the field of hearing devices and hearing systems, in particular to devices of a hearing system forming a network. It relates to methods and apparatuses according to the opening clauses of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

A hearing system comprises at least one hearing device. In case that a hearing system comprises at least one additional device, all devices of the hearing system are operationally connectable within the hearing system.

Typically, said additional devices such as another hearing device, a remote control or a remote microphone, are meant to be worn or carried by said individual.

### BACKGROUND OF THE INVENTION

In DE 10 2005 020 315 A1, a hearing aid remote control as a network component is disclosed.

From US 2006/0256987 A1, a hearing aid is known, which can be identified as the right or left hearing aid by means of a light-emitting devices at the hearing aid.

It is furthermore known to provide a remote control of a hearing system with a device identification individually identifying that specific remote control, and to store in each of the (one or two) hearing devices of the hearing system the device identification of that remote control. When the remote control sends a message meant for the hearing device(s), said device identification will be included in the message, and the receiving hearing device(s) will accept the message if the device identification is identical with the device identification stored in the hearing device(s) and reject/ignore the message otherwise. One can say, the hearing device(s) has/have stored a list of device identifications of all “accepted” devices. It is also said that in such a hearing system, the remote control is “paired” with the hearing device (or with each of the hearing devices). This way, it shall be ensured that a remote control works together solely with the hearing device(s) of the hearing system to which it belongs. In such a system, it is necessary to store one device identification per accessory (remote control and the like) in each hearing device. If the hearing system user wants to add an additional accessory to his hearing system, it is necessary to visit the hearing device professional, who then has to enter the device identification of the additional accessory in the hearing device(s).

It is desirable to provide an alternative way to ensure that a remote control works together solely with the hearing device(s) of the hearing system to which it belongs.

### SUMMARY OF THE INVENTION

One object of the invention is to create an alternative way, in particular an improved way, of managing a network interconnecting devices of a hearing system, in particular managing the handling of messages in such a network.

Another object of the invention is to provide an alternative way, in particular an improved way, of ensuring that a device of a hearing system works together solely with device of that hearing system to which it belongs.

Another object of the invention is to simplify provisions which have to be taken when adding a device to a hearing system the devices of which form a network.

Another object of the invention is to minimize the storage space required in devices of a hearing system for regulating the acceptance or non-acceptance of messages in said devices.

Another object of the invention is to minimize the effort required for regulating the acceptance or non-acceptance of messages in said devices and/or for maintaining data required therfor.

Further objects emerge from the description and embodiments below.

At least one of these objects is at least partially achieved by apparatuses and methods according to the patent claims.

The method for operating a hearing system comprises using a network identifier for identifying messages within a network formed by devices of said hearing system.

Through this, an improved message management can be achieved. Accordingly, it is not necessary to provide an identifier for each device of a hearing system (and to store lists of such device identifiers in the devices), but an identifier is used, which is specific for the network. It is thus easily possible to distinguish between messages within the hearing system, i.e. messages originating within the network and to be received by one or more devices participating in the network, and external messages, e.g., messages sent by a device of a second hearing system (belonging to another user) which happens to be located close to the first hearing system.

Usually, said network will be a wireless network.

Note that said “identifying messages” can on the one hand mean so much as labelling messages, marking messages, characterizing messages (as belonging to the network). On the other hand, nevertheless, said “identifying messages” can—additionally or alternatively—mean so much as recognizing messages (as belonging to the network), detecting messages (as belonging to the network).

Typically, said network identifier will be used for both, i.e. for marking messages as messages within the network and for recognizing messages as messages within the network.

The method may comprise the step of forming said network interconnecting said devices of said hearing system.

The device of a hearing system, in particular a hearing device, is configured to participate in a network, comprises a storage unit in which a network identifier is stored, and is configured to use said network identifier for identifying messages within said network.

The hearing system comprises a first device and a second device which are both configured to participate in a common network, wherein
said first device comprises a storage unit in which a network identifier is stored;
said second device comprises a storage unit in which the same network identifier is stored; and
said first device and said second device are both configured to use said network identifier for identifying messages within said common network.

In one embodiment of the method, said network identifier is common within said network. I.e. there is one network identifier throughout the network; one network identifier is characteristic for said network. This will usually be the case.

In one embodiment, said network identifier is stored in at least two, in particular in at least three of the devices participating in said network. For devices capable of transmitting messages, said network identifier can be retrieved from said storage unit for incorporating the network identifier in messages to be transmitted; and for devices capable of receiving messages, said network identifier can be retrieved from said storage unit for comparing it to network identifiers extracted from received messages. Note that it is possible that there are devices participating in the network, but which do not have the network identifier in a storage; such devices can make use of complementing data as will be discussed below.

In one embodiment, said network identifier is stored in each device participating in said network.

In one embodiment, the method comprises including said network identifier in transmitted messages.

In one embodiment, the method comprises carrying out in a device participating in said network the steps of
a) including a network identifier in a message to be transmitted; and
b) transmitting said message.

In one embodiment, step a) is replaced by the step of
a′) including in a message to be transmitted a network identifier and, in addition, complementing data.

It is possible that said complementing data are identical for all devices participating in the hearing system, but it is also possible that there are different complementing data provided by some of the devices participating in the hearing system or even by each of the devices participating in the hearing system.

In one embodiment, said complementing data describe at least one property of that device of said hearing system which carries out step b). Such a property may be a technical property of the device and/or a commercial property of the device. A property can depict a role the device shall have in the network, e.g., a specific device could be configured to be a master device in the sense that messages sent by that master device shall not be discarded because of the network identifier comprised in the message. Such a master device could be used by a hearing device professional, so as to allow the hearing device professional to use the master device for controlling devices of many different hearing systems (and networks) without the need to adjust the network identifier each time. Or, such a device could be a device in which a network identifier cannot or shall not be stored, e.g., because it is a low-cost device for which it is not worthwhile to undergo the process of storing a network identifier in it.

In one embodiment, the method comprises carrying out in a device participating in said network the steps of
c) receiving a message;
d) extracting a network identifier from the received message; and
e) comparing the received network identifier with a network identifier stored in a storage unit of said device.

In one embodiment, the method comprises treating further contents of said received message in dependence of the result of said comparison.

In one embodiment, the method comprises discarding said received message if said received network identifier is different from said network identifier stored in said storage unit of said device.

In one embodiment, the method comprises furtherly evaluating the message if said received network identifier is identical with said network identifier stored in said storage unit of said device.

In one embodiment, the method comprises the steps of
f) extracting complementing data from the received message; and
g) evaluating said complementing data;
   wherein, in dependence of the result of said evaluation, step e) is carried out or is not carried out. E.g., it is possible that because of the result of the evaluation, a device discards the message—even if the network identifier is “correct”, and it is also possible that a device further evaluates the message—even if the network identifier is not “correct” and not even checked. A “correct” network identifier is identical with the network identifier stored in the device. Accordingly, further contents of said received message is treated in dependence of the result of said evaluation.

Accordingly, in one embodiment, the method comprises, in dependence of said result of said evaluation, either the step of
h) accepting said message;
   or the step of
i) discarding said message.

In one embodiment of the hearing system, at least one of said first and said second devices is configured to include the network identifier stored in its storage unit in messages to be transmitted within said network.

In one embodiment of the hearing system, at least one of said first and said second devices is configured to include in messages to be transmitted within said network complementing data describing at least one property of the respective device.

In one embodiment of the hearing system, at least one of said first and said second devices is configured to receive messages, to extract a network identifier from received messages, and to compare the received network identifier with said network identifier stored in its storage unit.

In one embodiment of the hearing system, said at least one device is configured to treat further contents of said received message in dependence of the result of said comparison.

The invention comprises hearing devices and hearing systems with features of corresponding methods according to the invention, and vice versa.

The advantages of the methods correspond to the advantages of corresponding apparatuses and vice versa.

Further embodiments and advantages emerge from the dependent claims and the figures.

### BRIEF DESCRIPTION OF THE DRAWINGS

Below, the invention is described in more detail by means of examples and the included drawings. The figures show:

FIG. 1 a block diagram illustrating a method according to the invention;

FIG. 2 a schematic illustration of a hearing system according to the invention.

The reference symbols used in the figures and their meaning are summarized in the list of reference symbols. Generally, alike or alike-functioning parts are given the same or similar reference symbols. The described embodiments are meant as examples and shall not confine the invention.

### DETAILED DESCRIPTION OF THE INVENTION

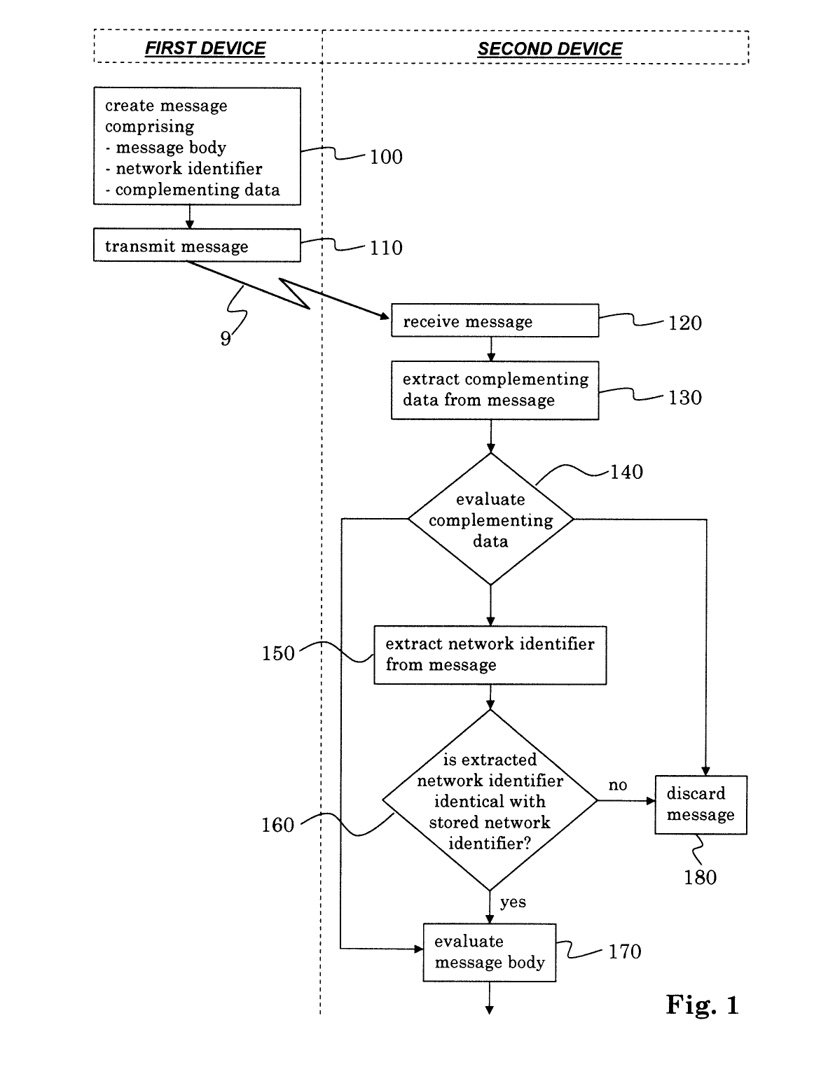

FIG. 1 shows a block diagram illustrating a method according to the invention. On the left-hand side of FIG. 1, steps taking place in a first device of a hearing system are shown, whereas on the right-hand side of FIG. 1, steps taking place in a second device of that hearing system are shown. Both devices participate in a network which interconnects some or all of the devices of the hearing system.

In step 100, a message is created comprising a message body, a network identifier and complementing data. For example, the message body can comprise a command such as a command to increase the output volume of the second device or to choose another hearing program; or the message body can comprise data forming an audio stream. By means of the network identifier, the message is identified (marked) as being a message within the network (a message belonging to the network).

Then, in step 110, the message 9 is transmitted, typically wirelessly. Other devices of the hearing system such as the second device will receive the message 9 (step 120).

In the second device, the complementing data will be extracted from the message 9 (step 130). In step 140, the complementing data will be evaluated. There are various possibilities as to what information the complementing data can carry. For example, the complementing data can indicate at least one of
properties of the device
type of the device (remote control, hearing device, . . . )
a role the device plays in a hearing system
technical properties of the device
commercial properties of the device
make or brand of the device
to which product line or product family the device belongs
to which price segment the device belongs.

As can be seen in FIG. 1, it is possible that as a result of the evaluation of the complementing data, the message body will be evaluated (step 170). This can, e.g., be the case if the complementing data indicate that the role of the device transmitting the message 9 is such that in any event (in particular independent of the network identifier), the message body has to be evaluated (step 170). Or, it is possible that as a result of the evaluation (step 140), the message is discarded (step 180). This can, e.g., be the case if the complementing data indicate that the transmitting device (first device) belongs to a product line or brand which is incompatible with the receiving device (second device). (Note that such an incompatibility can be due to technical and/or commercial reasons).

Furthermore, it is possible, that step 140 is followed by step 150, i.e. by the extraction of the network identifier from the message 9. By means of the network identifier, the receiving device (second device) can identify (recognize) the message 9 as a message within the network. I.e. the second device can detect by means of the network identifier whether or not a received message is a message within the network. Accordingly, it can be prevented, e.g., that when two hearing device users meet and one of them uses his hearing device remote control for adjusting the output level of his hearing devices (via a network formed by devices of his hearing system), the output level of the other user's hearing devices (which participate another network) will be adjusted too, which would, of course, be an undesired effect.

For finding out whether or not a received message belongs to the appropriate network, i.e. to the network in which the second device participates, the extracted network identifier will be compared to a network identifier comprised (stored) in the second device. If the two network identifiers agree, the message 9 will be considered as belonging to the appropriate network.

If the message is found to be not belonging to the appropriate network, it will be rejected/ignored (step 180), and no further evaluation of the message is necessary. If, on the other hand, it is found that the message originated from a device participating in the network, the remainder of the message, i.e. the message body will be evaluated (step 170). In dependence of the message body, further action can be taken, such as selecting another hearing program or initiating the transmission of an audio stream or whatever is contained or requested in the message body.

It can be provided that, if step 130 fails, because there are no complementing data comprised in the message 9, it will be continued with step 150. It is possible to provide that the inclusion of complementing data in a message is optional.

It can furthermore be provided that, if step 150 fails, because there is no network identifier comprised in the message 9, it will be continued with step 180, i.e. the message will be discarded.

It is possible to carry out the method generally without complementing data in messages and, accordingly, without steps 130 and 140.

The network identifier can just be some data such as a number or some code.

How does a network identifier get into a storage unit of a device? Network identifiers can be stored in a device by the manufacturer or the distributor of the device or by the user of the hearing system, e.g., via entering a special operating mode. It is possible that a hearing device professional enters the network identifier, e.g., using a software (fitting software) that is used for adjusting the device to the preferences of the hearing system user. It is also possible that there is no need to enter a network identifier by hand. A transmission of a network identifier from one device to another device can be provided. For example, the user has a hearing system comprising two hearing devices and buys a remote control for controlling his two hearing devices. For enabling that the new remote control works together with his hearing devices, a special mode could be activated in the remote control, in which a message (sent by one of the hearing devices)—possibly a special message—is accepted by the remote control, and a network identifier comprised in that message is extracted and stored in the remote control. From then on, messages transmitted by any one of the three devices of the hearing system can comprise the same network identifier, and each of the devices will be able to recognize such messages as belonging to the common (appropriate) network.

It is possible to control the access of a storage unit in which a network identifier can be stored. This way, it can be made possible to control the possibility to add a device to a hearing system network. In particular, it is possible to provide that the entering of a (new) network identifier in a storage unit of a device is made possible or impossible in dependence of a pre-defined condition. Such a condition may be, e.g., whether or not a license for entering a network identifier has been obtained and entered. This can be accomplished by, e.g., providing (e.g., from the manufacturer to a hearing device professional) a required code or key upon an appropriate payment. It is also possible that entering a network identifier is made possible or impossible in dependence of technical compatibility between the device to be added to the network and the devices already participating in the network. It is possible to use the fitting software for controlling the enabling/disabling of storing a network identifier in an appropriate storage unit of the device to be added to the network.

It is possible to provide that each message transmitted within the network comprises a network identifier, but it is also possible to provide that some messages transmitted within the network do not comprise a network identifier. The latter may be chosen, e.g., for system messages or for messages from special devices.

It is desirable to provide unique network identifiers. For practical reasons (data length; storage space required for a network identifier; administration of network identifiers), a sufficiently large number of network identifiers will be distributed—maybe within a geographical region—, and after a relatively long time, e.g., after several years, the same numbers may be distributed again, for other hearing systems and correspondingly other networks.

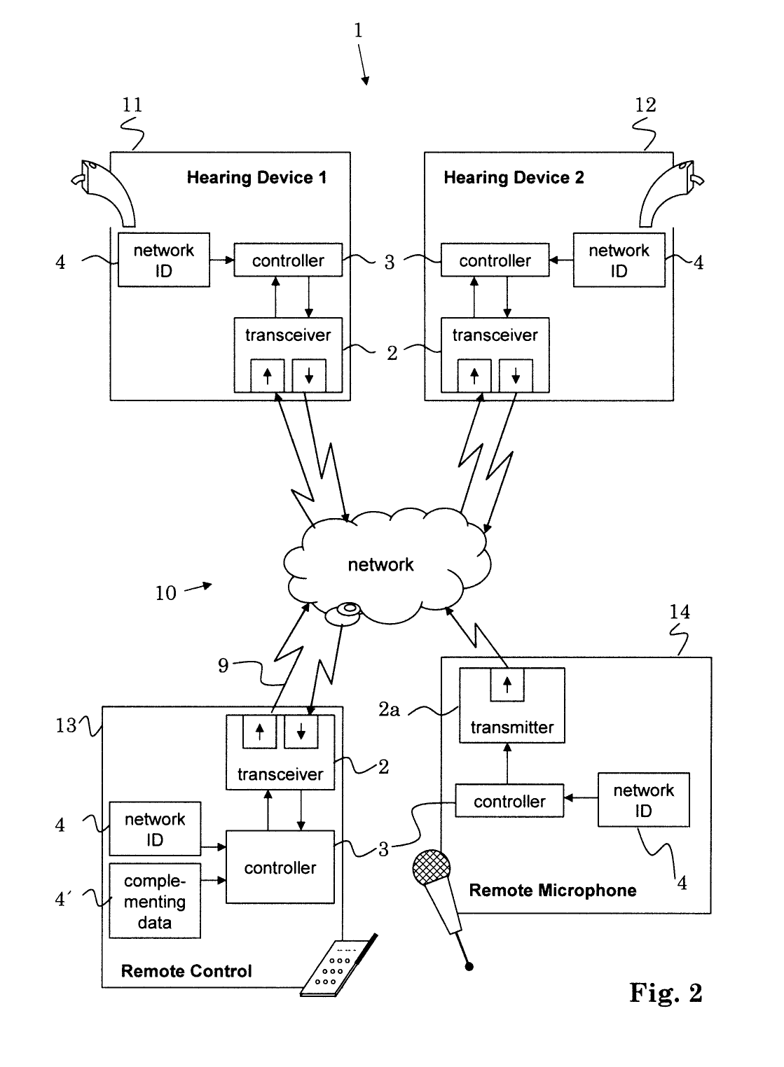

FIG. 2 shows a schematic illustration of a hearing system 1 according to the invention. By means of such a hearing system 1, it is possible to carry out a method like the one illustrated in FIG. 1.

The hearing system 1 comprises two hearing devices 11, 12, a remote control 13 and a remote microphone 14. All the devices 11, 12, 13, 14 of the hearing system 1 are operationally interconnected. All these devices 11, 12, 13, 14 participate in a network 10, preferably a wireless network.

Each of the devices 11, 12, 13, 14 has a unit 2 or 2a by means of which it can participate in the network. Devices 11, 12, 13 have transceiving units 2 (combination of receiving unit and transmission unit), i.e. they can transmit and receive messages within the network 10, whereas device 14 has a transmission unit 2a only and thus cannot receive messages from the network. It is also possible that devices participate in the network which can receive messages from the network but cannot transmit messages via the network 10.

Each of the devices 11, 12, 13, 14 has a control unit 3 and a storage unit 4 comprising a network identifier. A control unit 3 can manage the message handling in a device participating in a network, in particular by controlling the functioning of transceiving/transmission units and more particularly by creating messages to be transmitted (cf. FIG. 1, step 100) via the network, which messages comprise the network identifier stored on the storage unit 4 of the respective device. A control unit 3 (as in devices 11, 12, 13) can furthermore extract (cf. FIG. 1, step 150) a network identifier comprised in a received message and compare it (cf. FIG. 1, step 160) to a network identifier stored on the storage unit 4 of the device.

A control unit 3 can, in a similar way, also handle complementing data possibly comprised in messages 9. In the embodiment of FIG. 2, only device 13 has complementing data comprised in a storage unit (4′). Accordingly, only device 13 can transmit messages 9 comprising complementing data. The control units 3 of devices 11 and 12 will typically be configured to be able to extract complementing data from received message (cf. FIG. 1, step 130) and to evaluate them (FIG. 1, step 140).

In FIG. 2, further details of the devices 11, 12, 13, 14 are not drawn. For example, the hearing devices 11, 12 typically comprise an input converter, a signal processor and an output converter, and a remote control 13 typically comprises a user interface such as several buttons and possibly a display.

In the state of the art, where the acceptance/non-acceptance of messages is based on device identifiers, a device receiving messages will typically have the device identifiers of all those devices stored in a storage unit, which participate in the network. In larger hearing systems, this can amount to 5 or 6 or more device identifiers that have to be stored and to be maintained (adding, changing, removing). Using the present invention, only a single identifier is required, namely the network identifier, which is characteristic for the network itself. And, in addition, usually only that one device which is newly added to the network will have to be provided with new data (namely with the network identifier), whereas no modifications at the other devices are required, unlike the situation in the state of the art.

A typical method according to the invention comprises using a network identifier for distinguishing messages within the hearing system from external messages. Said distinguishing can on the one hand be a labelling or marking and on the other hand a recognizing.

In a certain view, a hearing system according to the invention can be considered a hearing system comprising at least two devices each of which comprises a storage unit comprising the same network identifier, wherein at least a first of said devices comprises a transmitting interface for transmitting (sending) messages, and at least a second of said devices comprises a receiving interface for receiving messages, wherein at least said at least one first device is configured to include said network identifier in messages to be transmitted via said transmitting interface, and wherein at least said at least one second device is configured to extract from messages received via said receiving interface a network identifier and to compare said received network identifier to said network identifier comprised in said storage unit of said at least one second device and to handle further data comprised in said message in dependence of the result of said comparison.

### LIST OF REFERENCE SYMBOLS

1 hearing system
2 transceiver, transmitting and receiving unit
2a transmitting unit, transmitter, sender
3 controller, control unit
4, 4′ storage unit
message
10 network, wireless network, short-distance network
11 device, hearing device
12 device, hearing device
13 device, remote control
14 device, remote microphone
100-180 steps

What is claimed is:

1. A method for operating a hearing system, comprising using a network identifier for identifying messages within a network formed by devices said hearing system.

2. The method according to claim 1, comprising using a network identifier for distinguishing messages within the hearing system from external messages.

3. The method according to claim 1, wherein said network identifier is common within said network.

4. The method according to claim 1, wherein said network identifier is stored in at least two of the devices participating in said network.

5. The method according to claim 1 comprising including said network identifier in transmitted messages.

6. The method according to claim 1, comprising carrying out in a device participating in said network the steps of
a) including a network identifier in a message to be transmitted; and
b) transmitting said message.

7. The method according to claim 6, wherein step a) is replaced by the step of
a′) including in a message to be transmitted a network identifier and, in addition, complementing data.

8. The method according to claim 7, wherein said complementing data describe at least one property of that device of said hearing system which carries out step b).

9. The method according to claim 1, comprising carrying out in a device participating in said network the steps of
c) receiving a message;
d) extracting a network identifier from the received message; and
e) comparing the received network identifier with a network identifier stored in a storage unit of said device.

10. The method according to claim 9, comprising treating further contents of said received message in dependence of the result of said comparison.

11. The method according to claim 10, comprising discarding said received message if said received network identifier is different from said network identifier stored in said storage unit of said device.

12. The method according to claim 9, comprising the steps of
f) extracting complementing data from the received message; and
g) evaluating said complementing data;
wherein, in dependence of the result of said evaluation, step e) is carried out or is not carried out.

13. The method according to claim 12, comprising, in dependence of said result of said evaluation, either the step of
h) accepting said message;
or the step of
i) discarding said message.

14. A hearing system comprising a first device and a second device which are both configured to participate in a common network, wherein
said first device comprises a storage unit in which a network identifier is stored;
said second device comprises a storage unit in which the same network identifier is stored; and
said first device and said second device are both configured to use said network identifier for identifying messages within said common network.

15. The hearing system according to claim 14, wherein at least one of said first and said second devices is configured to include the network identifier stored in its storage unit in messages to be transmitted within said network.

16. The hearing system according to claim 14 wherein at least one of said first and said second devices is configured to include in messages to be transmitted within said network complementing data describing at least one property of the respective device.

17. The hearing system according to claim 14, wherein at least one of said first and said second devices is configured to receive messages, to extract a network identifier from received messages, and to compare the received network identifier with said network identifier stored in its storage unit.

18. The hearing system according to claim 17, wherein said at least one device is configured to treat further contents of said received message in dependence of the result of said comparison.

19. A device of a hearing system, configured to participate in a network, comprising a storage unit in which a network identifier is stored, and configured to use said network identifier for identifying messages within said network.

20. The device according to claim 19, wherein said device is a hearing device.
